(19) United States
(12) Patent Application Publication
(10) Pub. No.: US 2009/0237561 A1
(43) Pub. Date: Sep. 24, 2009

(54) VIDEO AND AUDIO OUTPUT DEVICE

(76) Inventor: Kazuhiko Kobayashi, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/091,112

(22) PCT Filed: Oct. 23, 2006
(86) PCT No.: PCT/JP2006/321058

§ 371 Date: Apr. 22, 2008

(30) Foreign Application Priority Data
Oct. 26, 2005 (JP) 2005-310751

(51) Int. Cl. H04N 3/27

(52) U.S. Cl. 348/554; 348/E03.049

(57) ABSTRACT

There is a possibility that a critical problem occur, in a mobile device without a fixed service space such as a camcorder and the like on which the HDMI cable is frequently inserted/removed, when a piece of metal and the like fall in the HDMI terminal, causing the 5V terminal and other terminals to be short-circuited, there is a possibility that a critical problem which destroys the device arise. In an video and audio output device, a SW circuit (102) is provided between a 5V power source (405) and a 5V terminal (402), the SW circuit (102) is short-circuited when there is a bias in TMDS signal and the SW circuit is kept open when there is no bias in the TMDS signal. With this, when a cable is not connected, a supply of 5V power to the 5V terminal (402) is stopped.

### TECHNICAL FIELD

The present invention relates to video and audio output devices for transmitting video data and audio data. More particularly, the present invention relates to a video and audio output device which transmits video and audio data in the High Definition Multimedia Interface (HDMI) standard.

### BACKGROUND ART

Conventionally, the Digital Visual Interface (DVI) standard has been well known as a standard for transmitting video data as digital data. With this standard, pixel data in the primary color signals RGB is converted to digital data per pixel, and the video is digitally transmitted using an uncompressed baseband.

Meanwhile, in recent years, the HDMI standard has been established, in which a video and audio output device such as a DVD recorder and a video and audio reproduction device such as a TV are connected with a cable, and digital data outputted from the video and audio output device is transmitted to the video and audio reproduction device. With this technology, audio data is multiplexed, compressed, and superimposed in a blanking period of the video signals and simultaneously transmitted with video signals. This is highly convenient for a user since it is not necessary to connect an audio output terminal to a TV and the like aside from a video output terminal as in the conventional technology, and it is expected that the technology will be more widely used.

The data transmission using the HDMI based on the HDMI standard in non-patent reference 1 will be described with reference to the drawings. First, FIG. 5 shows a block diagram of a conventional video and audio output device.

Digital video data and audio data are transmitted from a transmitter 407 on the transmission side to a receiver 408 on the reception side. A video and audio output device 410 which is a video and audio signal source such as a DVD recorder includes the transmitter 407, and a video and audio reproduction device 412 includes the receiver 408. The transmitter 407 encodes video signals and audio signals and outputs the signals to the receiver 408. The transmitter 407 converts, by encoding, regarding the video data, video data of parallel 8 bits×3 channels into serial 10 bits×3 channels, and regarding audio data, audio data of parallel 4 bits into serial 10 bits. The receiver 408 decodes the video data and audio data transmitted from the transmitter 407 and converts the video data of serial 10 bits into parallel 8 bits, and the audio data of serial 10 bits into parallel 4 bits, and reproduces the video data and the audio data in the baseband.

The transmitter 407 and the receiver 408 are connected by is the Transition Minimized Differential Signaling (TMDS). The TMDS is a serial high-speed digital transmission method, and is a balanced (differential) type serial transmission method using three pairs of data signal lines and a pair of clock signal lines, and judges a signal by potential difference between two signal lines.

In addition, the HDMI cable includes a CEC signal line, a DDC signal line, an HPD signal line and a 5V line. The CEC 415 is an appliance control line Consumer Electronics Control (CEC), and transmits control signals for consumer appliances. The DDC 416 is a Display Data Channel (DDC) and transmits control signals for obtaining EDID information in the video and audio reproduction device such as a TV. The HPD 417 is a Hot Plug Detect (HPD), and is connected to a 5V terminal of the HDMI terminal in the video and audio reproduction device 412 via a 1KΩ resistor. The HPD is a signal for notifying a possible timing for obtaining the EDID information, when the video and audio output device 410 obtains EDID information of the video and audio reproduction device 412 using the DDC communication. The control of the timing when the EDID is available is performed by a HPD control unit (for example, a microcomputer 418) in the video and audio reproduction device 412. The 5V 414 is a 5V line, and supplies a voltage of 5V to the video and audio reproduction device 412.

[Non-patent reference 1] “High-Definition Multimedia Interface Specification Version 1.1” (May 20, 2004).

### DISCLOSURE OF INVENTION

### Problems that Invention is to Solve

A DVD recorder and an AV amplifier fixed indoor are mainly used as the video and audio output device 410. However, in recent years, the image quality of portable devices such as a camcorder and the like has been improved, and there has been a request for transmitting, via HDMI, image data and audio data on which image data of high image quality and audio data of high sound quality is recorded and reproduced for viewing on TV.

However, in a portable device such as a camcorder, for example, without a fixed service space and on which the HDMI cable is frequently inserted/removed, when a piece of metal and the like fall in the HDMI terminal and the 5V terminal, causing other terminals to be short-circuited, there is a possibility that a critical problem which destroys the device arises.

The present invention is conceived in order to solve the above problem and it is an object of the present invention to provide a video and audio output device which stops 5V output from the 5V terminal of the HDMI terminal when the video and audio output device having an HDMI function is not connected to the video and audio reproduction device via the HDMI cable.

### Means to Solve the Problems

In order to solve the above problem, the video and audio output device according to the present invention includes: a first terminal which outputs a video and audio signal to an external device via a first signal line; a second terminal which supplies voltage to the external device via a second signal line; a voltage supply unit operable to apply the voltage to the second terminal; a switch unit which is located between the second terminal and the voltage supply unit, and is for switching the application of the voltage from the voltage supply unit to the second terminal between ON and OFF; a connection judging unit operable to judge a connection status between the first terminal and the external device; and a control unit operable to control the application of the voltage from the voltage supply unit to the second terminal by switching the switch unit between ON and OFF, based on a result of the judgment by the connection judging unit.

### EFFECTS OF THE INVENTION

According to the video and audio output device of the present invention, since voltage is not applied to a voltage terminal when the voltage terminal is not connected to the video and audio reproduction device, it is possible to prevent the damage of an device even when metal pieces and the like falls in a connector, causing the voltage terminal of a connector and other terminal to be short-circuited.

### BRIEF DESCRIPTION OF DRAWINGS

FIG. 1 is a block diagram showing a video and audio output device according to an embodiment of the present invention.

FIG. 2 is a flowchart showing a flow of the video and audio output device according to an embodiment of the present invention.

FIG. 3 is a chart showing an algorithm of the ON/OFF setting unit in an embodiment of the present invention.

FIG. 4 is a timing chart of the video and audio output device according to the first embodiment of the present invention.

FIG. 5 is a block diagram showing a conventional video and audio output device.

### NUMERICAL REFERENCES

101 ON/OFF control signal
102 SW
103 Output port
401 Resistor
402 5V terminal
403 HPD terminal
404 1KΩ resistor
405 5V power supply
406 Microcomputer
407 HDMI transmitter
408 HDMI receiver
410 Video and audio output device
411 HDMI cable
412 Video and audio reproduction device
413 TMDS bias detection signal
414 5V
415 CEC signal
416 DDC signal
417 HPD signal
418 Microcomputer
419 Bias detection circuit

### BEST MODE FOR CARRYING OUT THE INVENTION

An embodiment of the present invention is explained in detail with reference to the drawings.

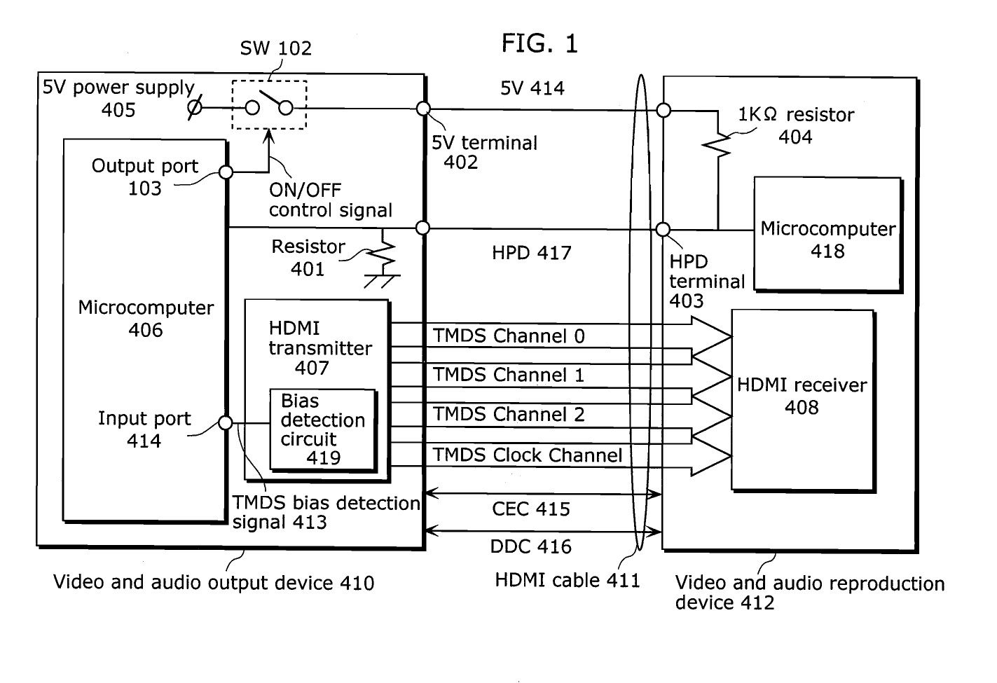

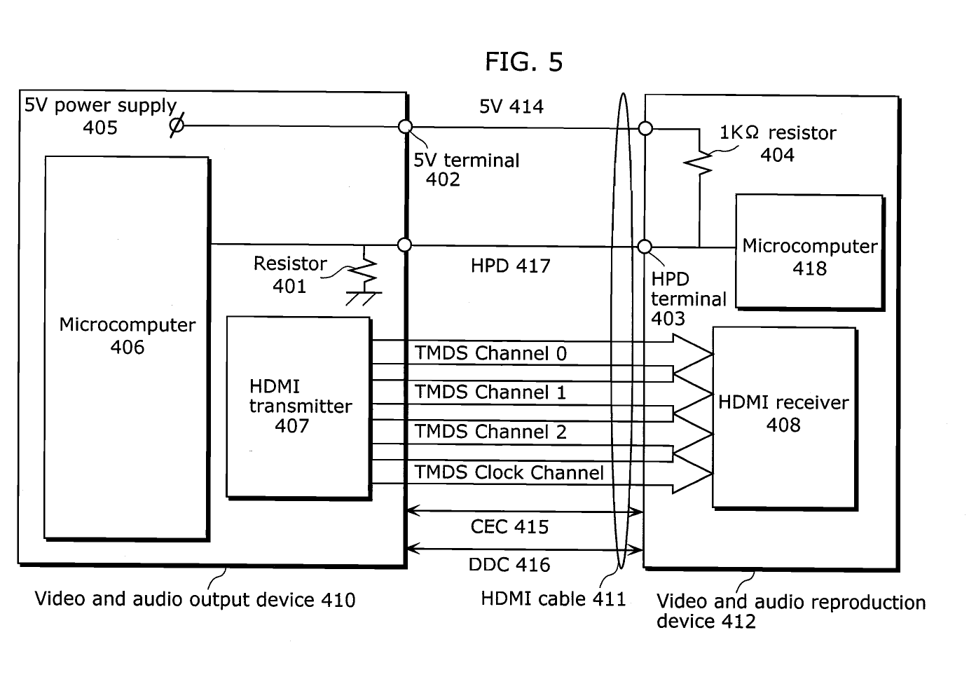

FIG. 1 is a block diagram showing a video and audio output device according to an embodiment of the present invention. In FIG. 1, the components in the block diagram of the conventional example shown in FIG. 5 are shown using the same reference numerals and the descriptions are omitted.

In FIG. 1, a bias detection circuit 419 detects a bias level of the TMDS signal. An SW unit 102 is an SW circuit to short-circuit or open the 5V power supply 405 and the 5V terminal of the HDMI terminal. The ON/OFF control signal 101 is a signal outputted from the output port 103 of the microcomputer, and the SW unit 102 is controlled using the signal.

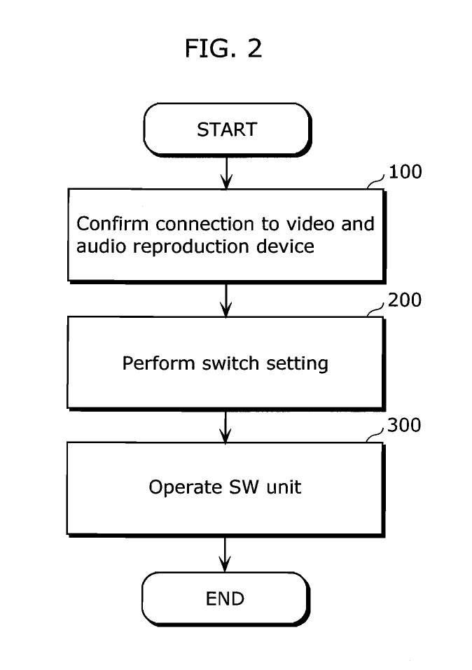

Next, operations of the video and audio output device 410 according to the present invention are described with reference to the flowchart shown in FIG. 2.

The video and audio output device 410 confirms that the video and audio output device 410 is connected to the video and audio reproduction device 412 via the HDMI cable 411 (Step 100). As a method to confirm the connection, a bias level of the TMDS signal or the HPD signal line is checked. Here, a method to check the bias level of the TMDS signal is described. The TMDS signal line is a current source of which the drain is open on the transmitter side, and is a differential receiver on the receiver side, and a positive side and a negative side of difference end in offset, at 50Ω and 3.3V respectively. If the power source of 3.3 V for TMDS is supplied on the receiver 408 side, it is easy to judge whether or not bias is applied on the transmitter side by the bias detection circuit 419 which compares the TMDS signal by a comparator and the like. The information regarding the detection obtained from the bias detection circuit 419 is inputted to the input port 414 of the microcomputer 406, and the video and audio output device 410 confirms that the video and audio output device 410 is connected to the video and audio reproduction device 412 with the HDMI cable 411.

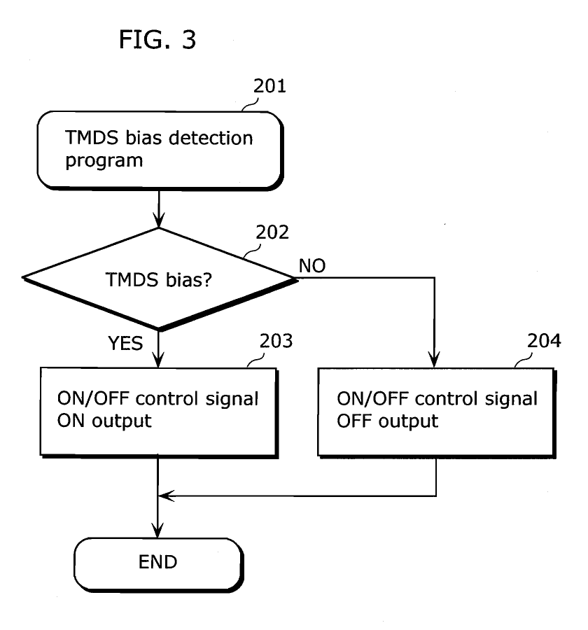

Next, the video and audio output device 410 executes the TMDS bias detection program on the microcomputer 406 and performs switch setting (Step 200). FIG. 3 is a diagram showing an algorithm of the ON/OFF setting unit. Step 202 is a judgment process, and monitors a level of the input port 414 in the microcomputer 406. When the input port 414 is set as High, it is judged that there is a TMDS bias and the process moves to Step 203. When the input port 414 is set as Low, it is judged that there is no TMDS bias, and the process moves to Step 204. Step 203 is a process that the output port 103 of the microcomputer 406 set the ON/OFF signal 101 as High. Step 204 is a process that the output port 103 of the microcomputer 406 set the ON/OFF signal 101 as Low.

Next the SW unit 102 controls voltage supply from the 5V power source 405 based on the inputted ON/OFF control signal 101 (Step 300). The SW unit 102 is short circuited when the ON/OFF control signal 101 is set as High, and supplies 5V from the 5V power source 405 to the 5V terminal 402 in the 5V power supply 405. In addition, the SW unit 102 is open when the ON/OFF control signal 101 is Low, and the 5V supplied from the 5V power source 405 is not supplied to the 5V terminal 402 of the HDMI terminal and the 5V terminal 402 is in high impedance.

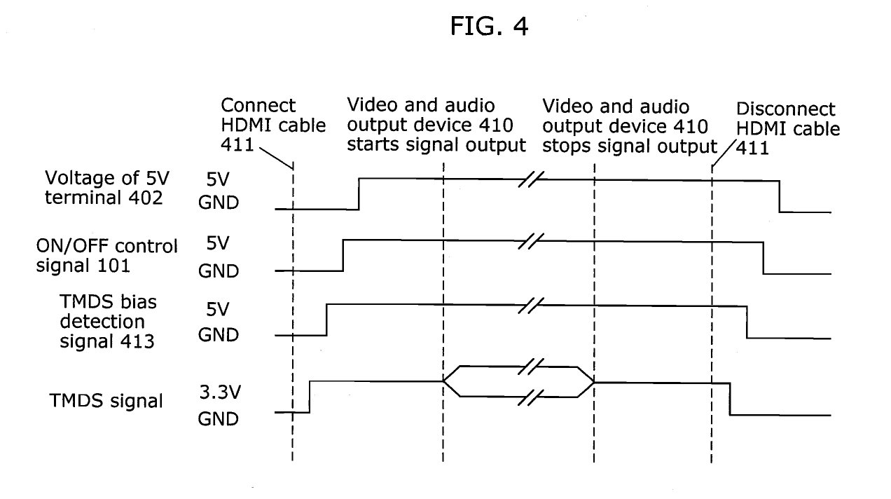

Next, the state of each signal in the video and audio output device 410 is explained with reference to the timing chart shown in FIG. 4. When the video and audio output device 410 and the video and audio reproduction device 412 are connected with the HDMI cable 411, the TMDS signal is biased. The bias detection circuit 419 set the level of the TMDS bias detection signal 413 as High. When the video and audio reproduction device 412 is not available for HDMI input, more specifically, when the video and audio output device 410 is not connected to the video and audio reproduction device 412 with the HDMI cable 411, or when the main power supply of the video and audio reproduction device 412 is switched off, the TMDS signal is not biased. The bias detection circuit 419 set the level of the TMDS bias detection signal 413 as low. The bias detection signal 413 is inputted to the input port of the microcomputer 406. The microcomputer 406 executes the algorithm of the ON/OFF setting unit shown in FIG. 3, and outputs the ON/OFF control signal 101 to the output port 103. The ON/OFF control signal 101 is a signal for controlling the SW unit 102 from the output port of the microcomputer. When the ON/OFF control signal 101 is in High level, the SW unit 102 is short-circuited and 5V from the 5V power source 405 is supplied to the 5V terminal 402 of the HDMI terminal. In addition, the SW unit 102 is open when the ON/OFF control signal 101 is Low, and 5V supplied from the 5V power source 405 is not supplied to the 5V terminal 402 and thus the 5V terminal 402 is in high impedance.

As described above, by detecting whether the TMDS signal is biased or not, and based on the detection result of the bias of the TMDS signal, 5V supply of 5V terminal in the HDMI terminal is controlled. With this, when the video and audio output device 410 is not connected to the video and audio reproduction device 412 with the HDMI cable, it is possible to stop the 5V supply to the 5V terminal of the HDMI terminal, and damage to a device caused by metal pieces and others fallen into the HDMI terminal can be prevented even when the 5V terminal of the HDMI terminal and other terminal is short-circuited.

Furthermore, by stopping the supply of 5V, the power consumption in the video and audio reproduction device 412 can be controlled, and thus it is possible to suppress the battery consumption and extend battery life when it is applied to a video and audio reproduction device such as a camcorder and the like.

Note that, in the above embodiment, a method to execute the algorithm in FIG. 3 using a microcomputer is explained, however, the bias detection signal 413 may be directly used as an ON/OFF signal of the SW unit 102.

In addition, it is possible to apply the DVD recorder, a device such as a camcorder, or a given AV device as a video and audio output device.

### INDUSTRIAL APPLICABILITY

The video and audio output device according to the present invention is capable of preventing the HDMI terminal not to apply 5V when the video and audio output device is not connected to the HDMI cable, and is useful for a video and audio output device for transmitting the video data and audio data based on the High Definition Multimedia Interface (HDMI) standard, and more particularly to portable devices such as a camcorder and the like with frequent insertion/removal of the HDMI cable and without a fixed place for use.

1. A video and audio output device comprising:
a first terminal which outputs a video and audio signal to an external device via a first signal line;
a second terminal which supplies voltage to the external device via a second signal line;
a voltage supply unit operable to apply the voltage to said second terminal;
a switch unit which is located between said second terminal and said voltage supply unit, and is for switching the application of the voltage from said voltage supply unit to said second terminal between ON and OFF;
a connection judging unit operable to judge a connection status between said first terminal and the external device; and
a control unit operable to control the application of the voltage from said voltage supply unit to said second terminal by switching said switch unit between ON and OFF, based on a result of the judgment by said connection judging unit.

2. The video and audio output device according to claim 1,
wherein said connection judging unit is operable to judge the connection status between said first terminal and the external device based on whether or not a bias is to be applied to said first terminal.

3. The video and audio output device according to claim 2,
wherein said control unit is operable to control said switch unit to be switched ON so as to apply the voltage from said voltage supply unit to said second terminal when said connection judging unit judges that the bias is to be applied to said first terminal, and is operable to control said switch unit to be switched OFF so as not to apply the voltage from said voltage supply unit to said second terminal when said connection judging unit judges that the bias is not to be applied to said first terminal.

4. The video and audio output device according to claim 1,
wherein said voltage supply unit supplies a voltage of 5V.

5. A video and audio output method for a video and audio output device including:
a first terminal which outputs a video and audio signal to an external device via a first signal line;
a second terminal which supplies voltage to the external device via a second signal line;
a voltage supply unit operable to apply the voltage to the second terminal; and
a switch unit which is located between the second terminal and the voltage supply unit, and is for switching the application of the voltage from the voltage supply unit to the second terminal between ON and OFF,
said video and audio output method comprising
judging a connection status between the first terminal and the external device, and
controlling the application of the voltage from the voltage supply unit to the second terminal by switching the switch unit between ON and OFF, based on a result of the judgment in said judging.

6. The video and audio output method according to claim 5,
wherein, in said judging, the connection status between the first terminal and the external device is judged based on whether or not a bias is to be applied to the first terminal.

7. The video and audio output method according to claim 6,
wherein, in said controlling, the switch unit is controlled to be switched ON so as to apply the voltage from the voltage supply unit when it is judged that the bias is to be applied to the first terminal in said judging, and is controlled to be switched OFF so as not to apply the voltage from the voltage supply unit when it is judged that the bias is not to be applied to the first terminal in said judging.

8. A program for a video and audio output device including:
a first terminal which outputs a video and audio signal to an external device via a first signal line;
a second terminal which supplies voltage to the external device via a second signal line;
a voltage supply unit operable to apply the voltage to the second terminal; and
a switch unit which is located between the second terminal and the voltage supply unit, and is for switching the application of the voltage from the voltage supply unit to the second terminal between ON and OFF,
said program causing a computer to execute:
judging a connection status between the first terminal and the external device, and
controlling the application of the voltage from the voltage supply unit to the second terminal by switching the switch unit between ON and OFF, based on a result of the judgment in said judging.

9. The program according to claim 8,
wherein, in said judging, the connection status between the first terminal and the external device is judged based on whether or not a bias is to be applied to the first terminal.

10. The program according to claim 9,
wherein, in said controlling, the switch unit is controlled to be switched ON so as to apply the voltage from the voltage supply unit to the second terminal when it is judged that the bias is to be applied to the first terminal in said judging, and is operable to control the switch unit to be switched OFF so as not to apply the voltage from the voltage supply unit to the second terminal when it is judged that the bias is not to be applied to the first terminal in said judging.
